(19) United States
(12) Patent Application Publication
(10) Pub. No.: US 2009/0295117 A1
(43) Pub. Date: Dec. 3, 2009

(54) ANTI-SLIP DEVICE FOR HEAVY CONSTRUCTION EQUIPMENT

(75) Inventor: Taek Woo LEE, Gimhae-si (KR)

Correspondence Address: LADAS & PARRY LLP, 26 WEST 61ST STREET, NEW YORK, NY, 10023, US

(73) Assignee: VOLVO CONSTRUCTION EQUIPMENT HOLDING SWEDEN AB.

(21) Appl. No.: 12/471,589

(22) Filed: May 26, 2009

(30) Foreign Application Priority Data
May 30, 2008 (KR) 10-2008-0050913

(51) Int. Cl. B60R 3/00

(52) U.S. Cl. 280/169

(57) ABSTRACT

In an anti-slip device for heavy construction equipment equipped with a plurality of ventilation holes and installed in one side of an equipment body, an anti-slip device for heavy construction equipment comprises a slip prevention plate which includes a support groove curved with a certain interval and disposed closer to the ventilation holes, and a fixing hole which passes through the support groove; and an anti-vibration stopper which includes a head part mounted on an upper side of the fixing hole, and a support part which supports a lower side of the fixing hole, and contacts with the upper surface of the equipment body and the support part, respectively. The anti-slip device for heavy construction equipment can reliably maintain an interval between a slip prevention plate and an equipment body with the help of an anti-vibration stopper for thereby effectively absorbing the weights and vibrations applied to a slip prevention plate.

### BACKGROUND OF THE INVENTION

1. Field of the Invention

The present invention relates to an anti-slip device for heavy construction equipment, and in particular to an anti-slip device for heavy construction equipment which makes it possible to prevent slip due to oil, lubricant or oily pollutants and to decrease noises by installing an anti-slip device in a heavy construction equipment cab, an engine room, an upper frame or somewhere else.

2. Description of the Prior Art

A heavy construction equipment such as an excavator, loader or the like necessarily uses an operation oil, lubricant or the like for a smooth operation of a lower frame as well as an upper frame including a cab, an engine room and other work devices. Heavy construction equipment inevitably has a slip phenomenon on a body surface since it is exposed to oil or oily pollutants all the time during a long time operation.

An anti-slip device is generally installed in one side of an equipment body connected to a cab or an engine room so as to prevent slip which could occur due to oily pollutants. The anti-slip device allows a worker to easily enter an equipment body when maintenance is needed, while providing a safe passage during a movement or transfer work of equipment.

FIG. 1 is a schematic view illustrating an installation state of a conventional anti-slip device for heavy construction equipment fixed in one side of an equipment body, and FIG. 2 is a schematic perspective view illustrating a lower side of an anti-slip device of FIG. 1.

As shown therein, a conventional anti-slip device includes a slip prevention plate 1 engaged in one side of an equipment body 2 with the help of a fixing member 4. A plurality of ventilation holes 3 are formed in the slip prevention plate 1 for allowing oil to drop on a lower side 1a. The ventilation holes give reliable friction forces when a worker walks thereon.

The conventional anti-slip device has a bending part 5 in an end of the slip prevention plate 1 with a certain height. A stopper pin member 6 is welded on a lower side 1a of the slip prevention plate 1 with a certain widthwise interval. In assembling process, the end of the slip prevention plate 1, the bending part 5 and the stopper pin member 6 are directly engaged to the upper side of the equipment body 2, so workers can do something on the upper surface of the slip prevention plate 1 without slip.

In the conventional anti-slip device, the bending part of the slip prevention and the stopper pin member are directly engaged while contacting with the equipment body made of steel, a lot of noises occur due to the weights of workers or the vibrations of equipment.

In addition, the conventional anti-slip device needs more work processes such as a bending process, a welding process or something along with complicated heavy steel materials, which might lead to a weight increase in view of facilities and a higher cost.

Since a bending space of a bending part is needed for a certain interval from the equipment body, and the stopper made of steel material is complicated in its arrangement, cleaning work or maintenance cannot be performed easily.

### SUMMARY OF THE INVENTION

Accordingly, it is an object of the present invention to provide an anti-slip device for heavy construction equipment which can reliably receive and absorb the weights of workers and the vibrations of equipment even hen lots of weights and vibrations are applied thereto.

It is another object of the present invention to provide an anti-slip device for heavy construction equipment which can easily maintain an interval between a slip prevention plate and an equipment body without a bending process or a welding process.

To achieve the above object, in an anti-slip device for heavy construction equipment equipped with a plurality of ventilation holes and installed in one side of an equipment body, there is provided an anti-slip device for heavy construction equipment which comprises a slip prevention plate which includes a support groove curved with a certain interval and disposed closer to the ventilation holes, and a fixing hole which passes through the support groove; and an anti-vibration stopper which includes a head part mounted on an upper side of the fixing hole, and a support part which supports a lower side of the fixing hole, and contacts with the upper surface of the equipment body and the support part, respectively.

The lower surface of the support part of the anti-vibration stopper is larger than the diameter of the fixing hole.

The anti-vibration stopper is made of a rubber stopper containing a rubber material.

The support groove is curved on an upper surface of the slip prevention plate in a concave shape toward an upper surface of the equipment body.

The head part and said support part are integrated.

Effects

The anti-slip device for heavy construction equipment according to the present invention can reliably maintain an interval between a slip prevention plate and an equipment body with the help of an anti-vibration stopper for thereby effectively absorbing the weights and vibrations applied to a slip prevention plate. In addition, it is possible to further enhance a slip prevention function and cleaning and maintenance works by allowing oil or oily pollutants to drop on the lower surface of a slip prevention plate.

### BRIEF DESCRIPTION OF THE DRAWINGS

The present invention will become better understood with reference to the accompanying drawings which are given only by way of illustration and thus are not limitative of the present invention, wherein;

FIG. 1 is a schematic view illustrating an installation state of a conventional anti-slip device for heavy construction equipment fixed in one side of an equipment body of heavy construction equipment;

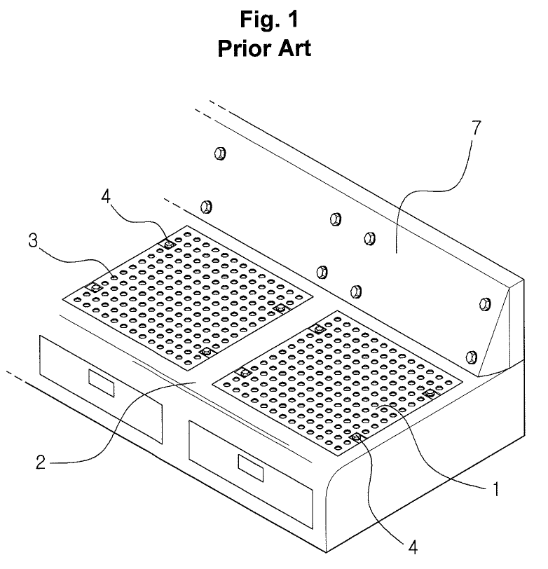

FIG. 2 is a schematic perspective view illustrating a lower side of a slip prevention device of FIG. 1;

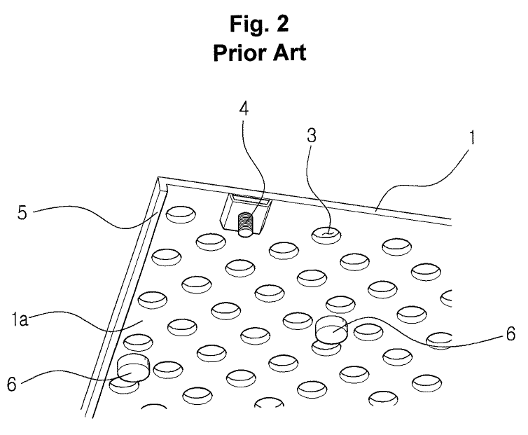

FIG. 3 is a schematic perspective view illustrating an ant-slip device for heavy construction equipment according to an embodiment of the present invention;

FIG. 4 is a partial cross sectional view illustrating an installation state of an anti-vibration stopper of FIG. 3; and

FIG. 5 is a schematic perspective view illustrating an installation state that an anti-slip device is attached to one side of an equipment body for heavy construction equipment according to an embodiment of the present invention.

### DETAILED DESCRIPTION OF THE PREFERRED EMBODIMENTS

The preferred embodiments of the present invention will be described with reference to the accompanying drawings.

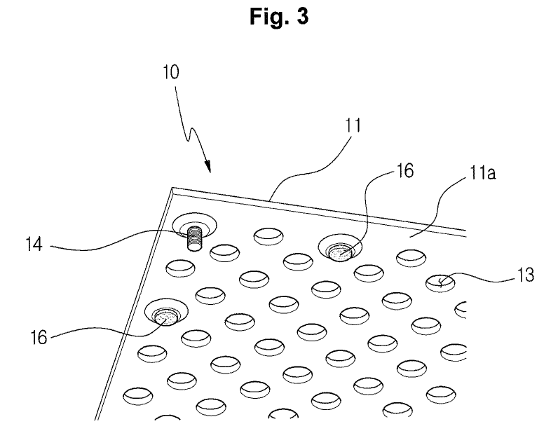

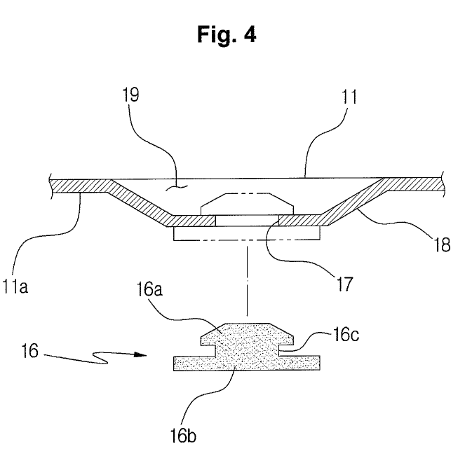

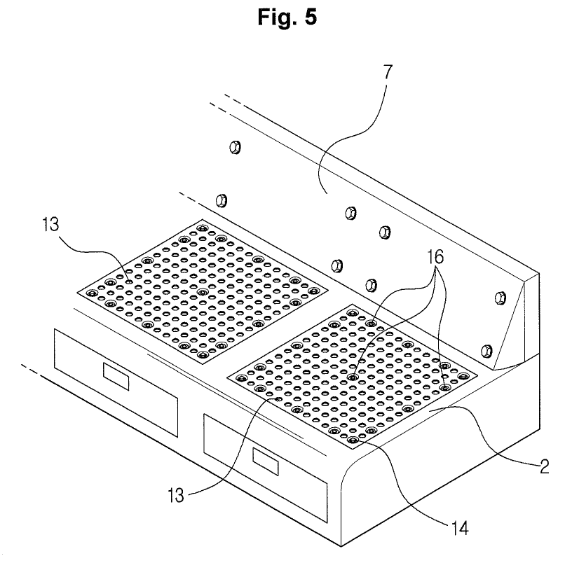

FIG. 3 is a schematic perspective view illustrating an ant-slip device for heavy construction equipment according to an embodiment of the present invention. FIG. 4 is a partial cross sectional view illustrating an installation state of an anti-vibration stopper of FIG. 3. FIG. 5 is a schematic perspective view illustrating an installation state that an anti-slip device is attached to one side of an equipment body for heavy construction equipment according to an embodiment of the present invention.

As shown in FIGS. 3 and 4, in an anti-slip device for heavy construction equipment equipped with a plurality of ventilation holes 13 and installed in one side of an equipment body 2, an anti-slip device for heavy construction equipment comprises a slip prevention plate 11 which includes a support groove curved 18 with a certain interval and disposed closer to the ventilation holes 13, and a fixing hole 17 which passes through the support groove 17; and an anti-vibration stopper 16 which includes a head part 16a mounted on an upper side of the fixing hole 17, and a support part 16b which supports a lower side of the fixing hole 17, and contacts with the upper surface of the equipment body 2 and the support part 16b, respectively.

The upper surface of the slip prevention plate 11 is equipped with a concave part 19 formed by curving a support groove 18. The structure of the support groove 18 can be modified in various shapes depending on the shape of the head part 16a of the anti-vibration stopper 16.

The lower surface of the support part 16b of the anti-vibration stopper 16 is larger than the diameter of the fixing hole 17. The support part 16b is provided so as to prevent an escape from the fixing hole 17 while supporting the weights or vibrations from the slip prevention plate 1.

In a preferred embodiment of the present invention, the support groove 18 is formed in a concave shape while extending from an upper surface of the slip prevention plate 11 to an upper surface of the equipment body 2.

In the present invention, the anti-vibration stopper 16 is preferably made of a rubber stopper having a rubber material or might be made of a stopper containing a urethane material or a flexible plastic material.

In the construction of the anti-vibration stopper 16, the head part 16a and the support part 16b are integrated, and the interval between the head part 16a and the support part 16b are limited by means of the stopper body 16c which is defined by means of the length inserted into the fixing hole 17 of the slip prevention plate 11.

A plurality of fixing members 14 are formed on a side surface of the slip prevention plate 11 while passing through the lower surface 11a and are engaged with the engaging holes(not shown) of the equipment body 2, respectively, and the fixing member 14 is provided so as to fix the slip prevention plate 11 and the equipment body 2.

In a preferred embodiment of the present invention, the slip prevention plate 11 might be installed in a multi-arrangement structure in a certain space set depending on the shape of the equipment body, for example, in a cab body or an engine room body and an upper frame body where a lot of oily pollutant occur.

The operation and operation principle of the anti-slip device for heavy construction equipment according to the present invention will be described.

In the anti-slip device for heavy construction equipment according to the present invention, the slip prevention plate 11 can be assembled to an equipment body where a lot of oily pollutants such as lubricant, operation oil, grease or the like occur, for example, to one side of an upper surface of the equipment body 2 using the fixing member 14.

The head parts 16a of the anti-vibration stoppers 16 are elastically inserted into the fixing grooves 17 formed in the support groove 18 and are mounted on the upper side of the fixing hole 17. The support part 16c of the anti-vibration stopper 16 is configured with its one side contacting with a lower side of the fixing hole 17 and being upwardly protruded toward the upper surface of the equipment body 2.

When the anti-slip device has been installed with the helps of the fixing member 14, a certain interval is formed between the lower side 11a of the slip prevention plate 11 and the upper surface of the equipment body 2.

The oil and oily pollutants dropped on the upper surface of the equipment body 2 are dropped into the space or interval formed below the lower side 11a of the slip prevention plate 11. The ventilation hole 13 helps decrease the contact cross-sectional area of the workers, which increases friction forces, so slip phenomenon can be basically prevented.

The anti-vibration stopper 16 according to the present invention performs an interval or space maintaining function between the slip prevention plate 11 and the equipment body 2. The weight applied to the slip prevention plate 1 is transferred to the equipment body 2 through the support grooves 18 and the support part 16b of the anti-vibration stopper 16. The transfer path of the vibrations to the slip prevention plate 11 is the same as the above. The weights and vibrations applied to the slip prevention plate 11 can be efficiently absorbed while passing through the anti-vibration stoppers 16 and the support parts 16b.

Since the side end of the slip prevention plate 11 is formed in a nearly plane shape, a bending process is not needed. When the device of the present invention is continuously adapted to a cam body, an engine room body and an upper frame, it is preferred that the side ends of the slip prevention plates used to engage the anti-vibration stopper 16 to the fixing hole are arranged while being closer to one another.

When the amounts of the oil or oily pollutants guided to the lower side 11a of the slip prevention plate 11 exceed a certain level, for example, when it exceeds the height of the support part 16b of the anti-vibration stopper 16, it is needed to clean and remove the oil and oily pollutants. At this time, a needed work can be easily performed by removing only the fixing member 14.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. In an anti-slip device for heavy construction equipment equipped with a plurality of ventilation holes and installed in one side of an equipment body, an anti-slip device for heavy construction equipment, comprising:
a slip prevention plate which includes a support groove curved with a certain interval and disposed closer to the ventilation holes, and a fixing hole which passes through the support groove; and
an anti-vibration stopper which includes a head part mounted on an upper side of the fixing hole, and a support part which supports a lower side of the fixing hole, and contacts with the upper surface of the equipment body and the support part, respectively.

2. The device of claim 1, wherein the lower surface of the support part of the anti-vibration stopper is larger than the diameter of the fixing hole.

3. The device of claim 1, wherein the anti-vibration stopper is made of a rubber stopper containing a rubber material.

4. The device of claim 1, wherein the support groove is curved on an upper surface of the slip prevention plate in a concave shape toward an upper surface of the equipment body.

5. The device of claim 1, wherein the head part and said support part are integrated.
